(19) United States
(12) Patent Application Publication
(10) Pub. No.: US 2025/0277986 A1
(43) Pub. Date: Sep. 4, 2025

(54) OPTICAL IMAGING SYSTEM WITH BUILT-IN OPTICAL FILTER BASED ON SMALL-ANGLE LIGHT PASSING

(71) Applicants: INSTITUTE OF FORENSIC SCIENCE, MINISTRY OF PUBLIC SECURITY, P.R.CHINA, Beijing (CN); NBL IMAGING SYSTEM LTD., Guangdong (CN)

(72) Inventors: Wei HUANG, Beijing (CN); Zhigang LI, Beijing (CN); Xudong LUO, Guangdong (CN); Guangyao LIU, Beijing (CN); Xuyi ZHANG, Beijing (CN); Xinyu HOU, Beijing (CN); Lei WANG, Beijing (CN); Yang ZHANG, Guangdong (CN); Dongzhuo LIU, Guangdong (CN)

(73) Assignees: INSTITUTE OF FORENSIC SCIENCE, MINISTRY OF PUBLIC SECURITY, P.R.CHINA, Beijing (CN); NBL IMAGING SYSTEM LTD., Guangdong (CN)

(21) Appl. No.: 18/859,544

(22) PCT Filed: Apr. 26, 2022
(86) PCT No.: PCT/CN2022/089264

§ 371 Date: Oct. 24, 2024

(51) Int. Cl. G02B 27/09; G02B 27/00

(52) U.S. Cl. CPC G02B 27/0988; G02B 27/0025

(57) ABSTRACT

An optical imaging system with a built-in optical filter based on small-angle light passing, includes a first group of lenses, an optical filter and a second group of lenses which are sequentially arranged from an imaging surface to an object surface. The first group of lenses and the second group of lenses are used to realize imaging by balancing aberrations via the refraction of light; all light rays emitted from the second group of lenses are incident to the optical filter at an included angle with an optical axis less than a set angle; and light rays emitted from the optical filter are coupled and imaged on the imaging surface through the first group of lenses. The optical imaging system with a built-in optical filter based on small-angle light passing can realize the spectral function of each nm of the test band by using a lens fused filter.

### TECHNICAL FIELD

The present invention relates to an optical imaging system with a built-in optical filter based on small-angle light passing, and relates to the field of optical lens design.

### BACKGROUND TECHNOLOGY

Due to the rapid development of modern science and technology, more and more fields need to integrate lens products to assemble a set of optical systems, and then use algorithms to realize the automatic measurement requirements.

As shown in FIG. 1, the traditional lens design only needs to satisfy the desired focal length, aperture and resolution, and the optical filter is installed outside of the lens. However, based on the requirements of system integration, an optical filter also needs to be installed inside the lens, and the optical filter built into the lens can reduce the volume of the imaging system and achieve portability and miniaturization.

The current lens design does not consider the issue of how to realize a lens with a built-in optical filter.

### SUMMARY OF THE INVENTION

With respect to the above issue, an object of the present invention is to provide an optical imaging system with a built-in optical filter based on small-angle light passing, which can integrate and miniaturize the whole spectral lens.

In order to realize the above object, the present invention adopts the following technical solution:

An optical imaging system with a built-in optical filter based on small-angle light passing, the system comprises a first group of lenses, an optical filter and a second group of lenses arranged sequentially from an imaging surface to an object surface, wherein the first group of lenses and the second group of lenses are used to realize imaging by balancing aberrations via the refraction of light, and all light rays emitted from the second group of lenses are incident to the optical filter at an included angle with an optical axis less than a set angle, and light rays emitted from the optical filter are coupled and imaged on the imaging surface through the first group of lenses.

The optical imaging system with the built-in optical filter, further from the imaging surface to the object surface, the first group of lenses sequentially comprise a first lens, a second lens, a third lens, a fourth lens, a fifth lens and a sixth lens; and the second group of lenses comprise a seventh lens and an eighth lens; wherein a spacing between the first lens and the second lens is 0.1 mm, a spacing between the third lens and the fourth lens is 15.9 mm, a spacing between the fourth lens and the fifth lens is 1.5 mm, a spacing between the fifth lens and the sixth lens is 0.3 mm, a spacing between the sixth lens and the seventh lens is 11 mm, and a spacing between the seventh lens and the eighth lens is 16.5 mm.

The optical imaging system with the built-in optical filter, further, the first lens has a refractive index of greater than 1.70 and less than 1.75, and a dispersion of greater than 45 and less than 55, the first lens is a spherical positive lens convex to imaging side, comprising a first convex spherical surface and a second convex spherical surface, and the design parameters of the first convex spherical surface are: Radius: −77 mm, Thickness: 49.2 mm, Clear Diam: 27.65529 mm; and the design parameters of the second convex spherical surface are: Radius: 108.8 mm, Thickness: 3.7 mm, Clear Diam: 27.52637 mm.

The optical imaging system with the built-in optical filter, further, the second lens has a refractive index of greater than 1.70 and less than 1.75, and a dispersion of greater than 50 and less than 60, the second lens is a spherical positive lens convex to imaging side, comprising a third convex spherical surface and a fourth convex spherical surface, and the design parameters of the third convex spherical surface are: Radius: −31.6 mm, Thickness: 0.1 mm, Clear Diam: 26.56407 mm; and the design parameters of the fourth convex spherical surface are: Radius: 91.2 mm, Thickness: 6.6 mm, Clear Diam: 24.74111 mm.

The optical imaging system with the built-in optical filter, further, the third lens has a refractive index of greater than 1.67 and less than 1.72, and a dispersion of greater than 50 and less than 60, the third lens comprises a fifth concave spherical surface and a sixth concave spherical surface, and the design parameters of the fifth concave spherical surface are: Radius: −23.2 mm, Thickness: 2 mm, Clear Diam: 21.99925 mm; and the design parameters of the sixth concave spherical surface are: Radius: 21.6 mm, Thickness: 15.9 mm, Clear Diam: 19.24685 mm.

The optical imaging system with the built-in optical filter, further, the fourth lens has a refractive index of greater than 1.55 and less than 1.60, and a dispersion of greater than 35 and less than 45, the fourth lens is a spherical positive lens concave to imaging side, comprising a seventh concave spherical surface and an eighth convex spherical surface, and the design parameters of the seventh concave spherical surface are: Radius: 145.2 mm, Thickness: 8.9 mm, Clear Diam: 26.09403 mm; and the design parameters of the eighth convex spherical surface are: Radius: 76.1 mm, Thickness: 1.5 mm, Clear Diam: 27.27495 mm.

The optical imaging system with the built-in optical filter, further, the fifth lens has a refractive index of greater than 1.74 and less than 1.79, and a dispersion of greater than 20 and less than 30, the fifth lens is a spherical positive lens concave to imaging side, comprising a ninth concave spherical surface and a tenth convex spherical surface, and the design parameters of the ninth concave spherical surface are: Radius: 32.3 mm, Thickness: 5.8 mm, Clear Diam: 30.27504 mm; and the design parameters of the tenth convex spherical surface are: Radius: 252.2 mm, Thickness: 0.3 mm, Clear Diam: 32.53857 mm.

The optical imaging system with the built-in optical filter, further, the sixth lens has a refractive index of greater than 1.70 and less than 1.75, and a dispersion of greater than 25 and less than 30, and the sixth lens is a spherical positive lens concave to imaging side, comprising an eleventh concave spherical surface and a twelfth convex spherical surface, and the design parameters of the eleventh concave spherical surface are: Radius: 44.4 mm, Thickness: 9.1 mm, Clear Diam: 35.48572 mm; and the design parameters of the twelfth convex spherical surface are: Radius: 252.2 mm, Thickness: 0.3 mm, Clear Diam: 38.61559 mm.

The optical imaging system with the built-in optical filter, further, the seventh lens has a refractive index of greater than 1.75 and less than 1.80, and a dispersion of greater than 45 and less than 55, and the seventh lens is a spherical negative lens concave to imaging side, comprising a thirteenth convex spherical surface and a fourteenth convex spherical surface, and the design parameters of the thirteenth convex spherical surface are: Radius: −98.4 mm, Thickness: 1 mm, Clear Diam: 39.27086 mm; and the design parameters of the fourteenth convex spherical surface are: Radius: 1683.7 mm, Thickness: 17.4 mm, Clear Diam: 38.78884 mm.

The optical imaging system with the built-in optical filter, further, the eighth lens has a refractive index of greater than 1.65 and less than 1.70, and a dispersion of greater than 25 and less than 35, and the eighth lens is a spherical negative lens concave to imaging side, comprising a fifteenth concave spherical surface and a sixteenth concave spherical surface, and the design parameters of the fifteenth concave spherical surface are: Radius: 3878.5 mm, Thickness. 16.5 mm, Clear Diam: 37.62764 mm; and the design parameters of the sixteenth concave spherical surface are: Radius: −80.8 mm, Thickness: 17.6 mm, Clear Diam: 36.94032 mm.

The present invention has the following characteristics due to the adoption of the above technical solutions: the present invention requires the use of lens fused filters to realize the spectral function of each nm of the test band, and since the built-in optical filter can only ensure that <7 degrees of light passes through it, at the same time, the optical filter needs to be located inside the lens, the built-in allows 7 degrees of light to pass through the optical filter with a thickness of about 13 mm, so that the whole spectral lens is integrated and miniaturized.

### DESCRIPTION OF DRAWINGS

Various other advantages and benefits will become clear to those skilled in the art by reading the detailed description of the preferred embodiment below. The accompanying drawings are used solely for the purpose of illustrating the preferred embodiments and are not to be considered as a limitation to the present invention. Throughout the accompanying drawings, the same parts are indicated by the same reference signs. In the accompanying drawings:

FIG. 1 is a LAYOUT diagram showing a prior art optical lens.

FIG. 2 is a structural diagram of an optical imaging system with a built-in optical filter according to an embodiment of the present invention.

FIG. 3 is a diagram showing the fingerprint effects obtained by ordinary photography according to an embodiment of the present invention.

FIG. 4 is a diagram showing the fingerprint effects obtained by the hyper-spectral lens according to an embodiment of the present invention.

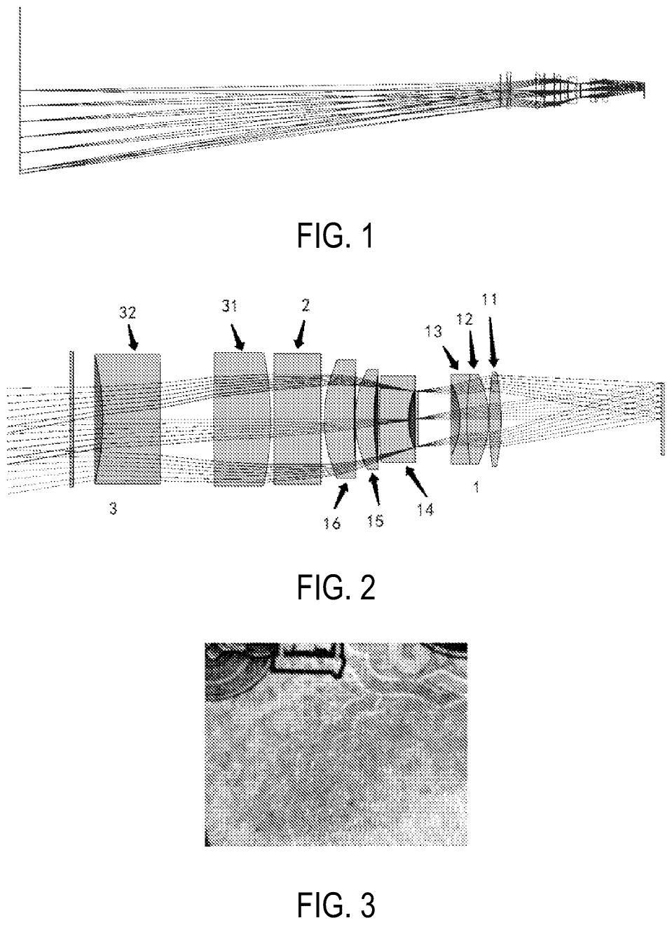

The reference signs in the accompanying drawings are:
1. a first group of lenses:
11. a first lens; 12. a second lens; 13. a third lens; 14. a fourth lens;
15. a fifth lens; and 16. a sixth lens;
2. an optical filter; and
3. a second group of lenses:
31. a seventh lens; and 32. an eighth lens.

### DETAILED DESCRIPTION

It should be understood that the terms used in the text are used only for the purpose of describing particular exemplary embodiments and are not intended to be limiting. The singular forms “a”, “an”, and “the” as used herein may also be intended to include the plural forms unless the context clearly indicates otherwise. The terms “including”, “comprising”, “containing”, and “having” are inclusive, and thus specify the presence of the stated features, steps, operations, elements and/or components, but does not preclude the presence or addition of one or more of other features, steps, operations, elements, components and/or the combination thereof. The method steps, processes and operations described herein are not to be construed as necessarily requiring that they are performed in the particular order described or illustrated unless the order of performance clearly indicated. It should also be understood that additional or alternative steps may be used.

For ease of description, spatial relativity terms, such as “inner”, “outer”, “inside,” “outside”, “below”, “above”, and the like may be used herein to describe the relationship of one element or feature relative to another element or feature as illustrated in the drawings. Such spatial relativity terms are intended to include different orientations of the device in use or operation other than those depicted in the drawings.

The present invention provides an optical imaging system with a built-in optical filter based on small-angle light passing, the system comprising a first group of lenses, an optical filter, and a second group of lenses arranged sequentially from an imaging surface to an object surface, wherein the first group of lenses and the second group of lenses are used to realize imaging by balancing aberrations via the refraction of light, and all light rays emitted from the second group of lenses are incident to the optical filter at an included angle with an optical axis less than a set angle, and light rays emitted from the optical filter are coupled and imaged on the imaging surface through the first group of lenses. The present invention uses the lens fused filter to realize the spectral function of each nm of the test band, so that the whole spectral lens is integrated and miniaturized.

Exemplary embodiments of the present invention will be described in more detail below with reference to the accompanying drawings. Although exemplary embodiments of the present invention are shown in the accompanying drawings, it should be understood that the present invention may be realized in various forms but should not be limited by the embodiments set forth herein. Rather, these embodiments are provided to enable a more thorough understanding of the present invention and to enable a complete communication of the scope of the present invention to those skilled in the art.

If a built-in optical filter is required in the lens, a reserved space needs to be provided inside the lens, and the built-in optical filter requires that the light ray must be less than a certain angle (e.g., less than 7 degrees) in order to pass through the lens, otherwise it will not be able to pass through the built-in optical filter, and if a built-in optical filter is required to achieve the purpose of testing a spectrum, the angle of the light needs to be controlled when designing.

As shown in FIG. 2, this embodiment provides an optical imaging system with a built-in optical filter based on a small angle light passing, with space reserved internally for the optical filter, at the same time, all light angles at the reserved position need to be <7 degrees; in order to meet the use requirements of the optical filter, a first group of lenses 1, an optical filter 2 and a second group of lenses 3 are sequentially arranged from an imaging surface to an object surface, the first group of lenses 1 and the second group of lenses 2 realize imaging by balancing aberrations via the refraction of light, so as to achieve the parameter requirements. All light rays emitted from the second group of lenses 3 are incident to the optical filter 2 at an included angle with an optical axis less than a set angle, and light rays emitted from the optical filter 2 are coupled and imaged on the imaging surface through the first group of lenses 1.

The first group of lenses 1 sequentially comprise a first lens 11, a second lens 12, a third lens 13, a fourth lens 14, a fifth lens 15, and a sixth lens 16 from imaging side; and the second group of lenses 3 comprise a seventh lens 31 and an eighth lens 32. Wherein, a spacing between the first lens 11 and the second lens 12 is 0.1 mm, a spacing between the third lens 13 and the fourth lens 14 is 15.9 mm, a spacing between the fourth lens 14 and the fifth lens 15 is 1.5 mm, a spacing between the fifth lens 15 and the sixth lens 16 is 0.3 mm, a spacing between the sixth lens 15 and the seventh lens 31 is 11 mm, and a spacing between the seventh lens 31 and the eighth lens 32 is 16.5 mm.

All light rays emitted from the second group of lenses 2 have an included angle of <7 degrees with the optical axis, i.e., the incident light rays of the optical filter 2 are all less than 7 degrees, and light rays emitted from the optical filter 2 are coupled and imaged on the imaging surface through the first group of lenses 1 to realize the testing requirements.

In a preferred embodiment of the present invention, as shown in Table 1, the first lens 11 is a spherical positive lens convex to imaging side, comprising a first convex spherical surface and a second convex spherical surface, and the design parameters of the first convex spherical surface are: Radius: −77, Thickness: 49.2, Clear Diam (optical aperture): 27.65529; the design parameters of the second convex spherical surface are: Radius: 108.8, Thickness: 3.7, Clear Diam: 27.52637, and the first lens 11 has a refractive index of greater than 1.70 and less than 1.75, and a dispersion of greater than 45 and less than 55, wherein all the dimensional parameters involved are in mm.

In a preferred embodiment of the present invention, as shown in Table 1, the second lens 12 is a spherical positive lens convex to imaging side, comprising a third convex spherical surface and a fourth convex spherical surface, and the design parameters of the third convex spherical surface are: Radius: −31.6, Thickness: 0.1, Clear Diam: 26.56407; the design parameters of the fourth convex spherical surface are: Radius: 91.2, Thickness: 6.6, Clear Diam: 24.74111, and the second lens 12 has a refractive index of greater than 1.70 and less than 1.75, and a dispersion of greater than 50 and less than 60, wherein all the dimensional parameters involved are in mm.

In a preferred embodiment of the present invention, as shown in Table 1, the third lens 13 is a spherical positive lens concave to imaging side, comprising a fifth concave spherical surface and a sixth concave spherical surface, and the design parameters of the fifth concave spherical surface are: Radius: −23.2, Thickness: 2, Clear Diam: 21.99925; the design parameters of the sixth concave spherical surface are: Radius: 21.6, Thickness: 15.9, Clear Diam: 19.24685, and the third lens 13 has a refractive index of greater than 1.67 and less than 1.72, and a dispersion of greater than 50 and less than 60, wherein all dimensional parameters involved are in mm.

In a preferred embodiment of the present invention, as shown in Table 1, the fourth lens 14 is a spherical positive lens concave to imaging side, comprising a seventh concave spherical surface and an eighth convex spherical surface, and the design parameters of the seventh concave spherical surface are: Radius: 145.2, Thickness: 8.9, Clear Diam: 26.09403; the design parameters of the eighth convex spherical surface are: Radius: 76.1, Thickness: 1.5, Clear Diam: 27.27495, and the fourth lens 14 has a refractive index of greater than 1.55 and less than 1.60, and a dispersion of greater than 35 and less than 45, wherein all the dimensional parameters involved are in mm.

In a preferred embodiment of the present invention, as shown in Table 1, the fifth lens 15 is a spherical positive lens concave to imaging side, comprising a ninth concave spherical surface and a tenth convex spherical surface, and the design parameters of the ninth concave spherical surface are: Radius: 32.3, Thickness: 5.8, Clear Diam: 30.27504; the design parameters of the tenth convex spherical surface are: Radius: 252.2, Thickness: 0.3, Clear Diam: 32.53857, and the fifth lens has a refractive index of greater than 1.74 and less than 1.79, and a dispersion of greater than 20 and less than 30, wherein all the dimensional parameters involved are in mm.

In a preferred embodiment of the present invention, as shown in Table 1, the sixth lens 16 is a spherical positive lens concave to imaging side, comprising an eleventh concave spherical surface and a twelfth convex spherical surface, and the design parameters of the eleventh concave spherical surface are: Radius: 44.4, Thickness: 9.1, Clear Diam: 35.48572; the design parameters of the twelfth convex spherical surface are: Radius: 252.2, Thickness: 0.3, Clear Diam: 38.61559, and the sixth lens 16 has a refractive index of greater than 1.70 and less than 1.75, and a dispersion of greater than 25 and less than 30, wherein all the dimensional parameters involved are in mm.

In a preferred embodiment of the present invention, as shown in Table 1, the seventh lens 31 is a spherical negative lens concave to imaging side, comprising a thirteenth convex spherical surface and a fourteenth convex spherical surface, and the design parameters of the thirteenth convex spherical surface are: Radius: −98.4, Thickness: 1, Clear Diam: 39.27086; the design parameters of the fourteenth convex spherical surface are: Radius: 1683.7, Thickness: 17.4, Clear Diam: 38.78884, and the seventh lens 31 has a refractive index of greater than 1.75 and less than 1.80, and a dispersion of greater than 45 and less than 55, wherein all the dimensional parameters involved are in mm.

In a preferred embodiment of the present invention, as shown in Table 1, the eighth lens 32 is a spherical negative lens concave to imaging side, comprising a fifteenth concave spherical surface and a sixteenth concave spherical surface, and the design parameters of the fifteenth concave spherical surface are: Radius: 3878.5, Thickness: 16.5, Clear Diam: 37.62764; the design parameters of the sixteenth concave spherical surface are: Radius: −80.8, Thickness: 17.6, Clear Diam: 36.94032, and the eighth lens 31 has a refractive index of greater than 1.65 and less than 1.70, and a dispersion of greater than 25 and less than 35, wherein all the dimensional parameters involved are in mm.

In a preferred embodiment of the present invention, the first lens 11, the second lens 12, the third lens 13, the fourth lens 14, the fifth lens 15, the sixth lens 16, the seventh lens 31 and the eighth lens 32 are all made of glass materials.

In a preferred embodiment of the present invention, based on the front light path, the angle within the optical filter 2 is less than 7 degrees to ensure that the focal length of the imaging system meets the standard: EFFL: 60 mm, FNO: F2.8, the size of the target surface: 1 inch, BFL: 49.2 mm.

TABLE 1
the parameters of each lens

| | | | | | | Clear | |
|---|---|---|---|---|---|---|---|
| Surf | Type | Radius | Thickness | Nd | Vd | Diam. | |
| 1 | STANDARD | Infinity | 10 | | | 39.14901 | |
| 2 | STANDARD | −80.8 | 17.6 | 1.733501 | 51.779678 | 36.94032 | The 8^{th} lens |
| 3 | STANDARD | 3878.5 | 16.5 | | | 37.62764 | |
| 4 | STANDARD | 1683.7 | 17.4 | 1.72916 | 54.499235 | 38.78884 | The 7^{th} lens |
| 5 | STANDARD | −98.4 | 1 | | | 39.27086 | |
| 6 | STANDARD | Infinity | 10 | | | 38.61559 | |
| 7 | STANDARD | 44.4 | 9.1 | 1.691002 | 54.708408 | 35.48572 | The 6^{th} lens |
| 8 | STANDARD | 252.2 | 0.3 | | | 32.53857 | |
| 9 | STANDARD | 32.3 | 5.8 | 1.57501 | 41.509668 | 30.27504 | The 5^{th} lens |
| 10 | STANDARD | 76.1 | 1.5 | | | 27.27495 | |
| 11 | STANDARD | 145.2 | 8.9 | 1.761823 | 26.552048 | 26.09403 | The 4^{th} lens |
| 12 | STANDARD | 21.6 | 15.9 | | | 19.24685 | |
| 13 | STANDARD | −23.2 | 2 | 1.728252 | 28.319563 | 21.99925 | The 3rd lens |
| 14 | STANDARD | 91.2 | 6.6 | 1.7725 | 49.620227 | 24.74111 | The 2^{nd} lens |
| 15 | STANDARD | −31.6 | 0.1 | | | 26.56407 | |
| 16 | STANDARD | 108.8 | 3.7 | 1.68893 | 31.250146 | 27.52637 | The 1^{st} lens |
| 17 | STANDARD | −77 | 49.2 | | | 27.65529 | |
| IMA | STANDARD | Infinity | | | | 19.50551 | |

The application of the optical imaging system with a built-in optical filter based on small-angle light passing of the present invention is described in detail below by means of specific examples.

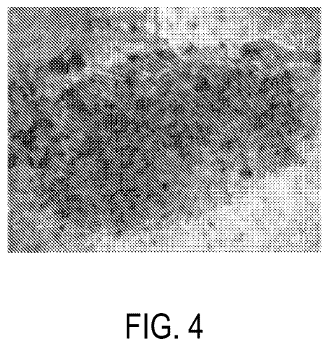

For example, there is serious background interference with sweat fingerprints on a 10 Yuan Renminbi, and after treatment by ninhydrin, as shown in FIG. 3, the fingerprint effect obtained by ordinary color photography are unsatisfactory. More valuable grain line images can be obtained by collecting the spectral image data via the portable multispectral fusion hyperspectral lens of the present invention, and via the MISystem evidence identification imaging spectral image analysis software using the algorithm of the evidence component analysis, as shown in FIG. 4.

Each embodiment in this specification is described in a progressive manner, and the same or similar parts among embodiments can be referred to each other, and each embodiment focuses on the differences from other embodiments. In the description of the present specification, the description with reference to the terms “an embodiment”, “some implementations”, etc. means that the specific features, structures, materials or characteristics described in conjunction with the embodiment or example are included in at least one embodiment or example of the embodiments of the present specification. In the present specification, the schematic expressions of the above terms do not necessarily refer to the same embodiment or example. Moreover, the specific features, structures, materials or characteristics described may be combined in a suitable manner in any one or more of the embodiments or examples. In addition, without contradicting with each other, those skilled in the art may join and combine different embodiments or examples and features of different embodiments or examples described in this specification.

Finally, it should be noted that the above embodiments are only used to illustrate the technical solution of the present invention, and not to be limiting; although the present invention has been described in detail with reference to the previous embodiments, those skilled in the art should understand that they can still make modifications to the technical solutions recorded in the previous embodiments, or make equivalent substitutions to some of the technical features therein; and these modifications or substitutions do not detach the essence of the corresponding technical solutions from the spirit and scope of the technical solutions of the embodiments of the present invention.

In the claims:

1. An optical imaging system with a built-in optical filter based on small-angle light passing, wherein the system comprises a first group of lenses, an optical filter and a second group of lenses arranged sequentially from an imaging surface to an object surface, wherein the first group of lenses and the second group of lenses are used to realize imaging by balancing aberrations via the refraction of light, and all light rays emitted from the second group of lenses are incident to the optical filter at an included angle with an optical axis less than a set angle, and light rays emitted from the optical filter are coupled and imaged on the imaging surface through the first group of lenses.

2. The optical imaging system with the built-in optical filter according to claim 1, wherein from the imaging surface to the object surface, the first group of lenses sequentially comprise a first lens, a second lens, a third lens, a fourth lens, a fifth lens and a sixth lens; and the second group of lenses comprise a seventh lens and an eighth lens; wherein a spacing between the first lens and the second lens is 0.1 mm, a spacing between the third lens and the fourth lens is 15.9 mm, a spacing between the fourth lens and the fifth lens is 1.5 mm, a spacing between the fifth lens and the sixth lens is 0.3 mm, a spacing between the sixth lens and the seventh lens is 11 mm, and a spacing between the seventh lens and the eighth lens is 16.5 mm.

3. The optical imaging system with the built-in optical filter according to claim 2, wherein the first lens has a refractive index of greater than 1.70 and less than 1.75, and a dispersion of greater than 45 and less than 55, the first lens is a spherical positive lens convex to imaging side, comprising a first convex spherical surface and a second convex spherical surface, and the design parameters of the first convex spherical surface are: Radius: −77 mm, Thickness: 49.2 mm, Clear Diam: 27.65529 mm, and the design parameters of the second convex spherical surface are: Radius: 108.8 mm, Thickness: 3.7 mm, Clear Diam: 27.52637 mm.

4. The optical imaging system with the built-in optical filter according to claim 2, wherein the second lens has a refractive index of greater than 1.70 and less than 1.75, and a dispersion of greater than 50 and less than 60, and the second lens is a spherical positive lens convex to imaging side, comprising a third convex spherical surface and a fourth convex spherical surface, and the design parameters of the third convex spherical surface are: Radius: −31.6 mm, Thickness: 0.1 mm, Clear Diam: 26.56407 mm; and the design parameters of the fourth convex spherical surface are: Radius: 91.2 mm, Thickness: 6.6 mm, Clear Diam: 24.74111 mm.

5. The optical imaging system with the built-in optical filter according to claim 2, wherein the third lens has a refractive index of greater than 1.67 and less than 1.72, and a dispersion of greater than 50 and less than 60, and the third lens comprises a fifth concave spherical surface and a sixth concave spherical surface, and the design parameters of the fifth concave spherical surface are: Radius: −23.2 mm, Thickness: 2 mm. Clear Diam: 21.99925 mm; and the design parameters of the sixth concave spherical surface are: Radius: 21.6 mm, Thickness: 15.9 mm, Clear Diam: 19.24685 mm.

6. The optical imaging system with the built-in optical filter according to claim 2, wherein the fourth lens has a refractive index of greater than 1.55 and less than 1.60, and a dispersion of greater than 35 and less than 45, and the fourth lens is a spherical positive lens concave to imaging side, comprising a seventh concave spherical surface and an eighth convex spherical surface, and the design parameters of the seventh concave spherical surface are: Radius: 145.2 mm, Thickness: 8.9 mm, Clear Diam: 26.09403 mm; and the design parameters of the eighth convex spherical surface are: Radius: 76.1 mm, Thickness: 1.5 mm, Clear Diam: 27.27495 mm.

7. The optical imaging system with the built-in optical filter according to claim 2, wherein the fifth lens has a refractive index of greater than 1.74 and less than 1.79, and a dispersion of greater than 20 and less than 30, and the fifth lens is a spherical positive lens concave to imaging side, comprising a ninth concave spherical surface and a tenth convex spherical surface, and the design parameters of the ninth concave spherical surface are: Radius: 32.3 mm, Thickness: 5.8 mm, Clear Diam: 30.27504 mm; and the design parameters of the tenth convex spherical surface are: Radius: 252.2 mm, Thickness: 0.3 mm, Clear Diam: 32.53857 mm.

8. The optical imaging system with the built-in optical filter according to claim 2, wherein the sixth lens has a refractive index of greater than 1.70 and less than 1.75, and a dispersion of greater than 25 and less than 30, and the sixth lens is a spherical positive lens concave to imaging side, comprising an eleventh concave spherical surface and a twelfth convex spherical surface, and the design parameters of the eleventh concave spherical surface are: Radius: 44.4 mm, Thickness: 9.1 mm, Clear Diam: 35.48572 mm; and the design parameters of the twelfth convex spherical surface are: Radius: 252.2 mm, Thickness: 0.3 mm, Clear Diam: 38.61559 mm.

9. The optical imaging system with the built-in optical filter according to claim 2, wherein the seventh lens has a refractive index of greater than 1.75 and less than 1.80, and a dispersion of greater than 45 and less than 55, and the seventh lens is a spherical negative lens concave to imaging side, comprising a thirteenth convex spherical surface and a fourteenth convex spherical surface, and the design parameters of the thirteenth convex spherical surface are: Radius: −98.4 mm, Thickness: 1 mm, Clear Diam: 39.27086 mm; and the design parameters of the fourteenth convex spherical surface are: Radius: 1683.7 mm, Thickness: 17.4 mm, Clear Diam: 38.78884 mm.

10. The optical imaging system with the built-in optical filter according to claim 2, wherein the eighth lens has a refractive index of greater than 1.65 and less than 1.70, and a dispersion of greater than 25 and less than 35, and the eighth lens is a spherical negative lens concave to imaging side, comprising a fifteenth concave spherical surface and a sixteenth concave spherical surface, and the design parameters of the fifteenth concave spherical surface are: Radius:3878.5 mm, Thickness: 16.5 mm, Clear Diam: 37.62764 mm; and the design parameters of the sixteenth concave spherical surface are: Radius: −80.8 mm, Thickness: 17.6 mm, Clear Diam: 36.94032 mm.
